(19) United States
(12) Patent Application Publication
(10) Pub. No.: US 2010/0312909 A1
(43) Pub. Date: Dec. 9, 2010

(54) METHOD AND SYSTEM FOR TRAFFIC BASED DECISIONS FOR ENERGY EFFICIENT NETWORKING

(76) Inventor: Wael William Diab, San Francisco, CA (US)

Correspondence Address: MCANDREWS HELD & MALLOY, LTD, 500 WEST MADISON STREET, SUITE 3400, CHICAGO, IL, 60661, US

(21) Appl. No.: 12/480,653

(22) Filed: Jun. 8, 2009

(51) Int. Cl. G06F 15/16; G06F 1/32

(52) U.S. Cl. 709/238; 709/234; 713/320; 709/206; 709/230

(57) ABSTRACT

Aspects of a method and system for traffic based decisions for energy efficient networking are provided. In this regard, a network device may determine whether to transition out of an energy-saving mode based on a type and/or class of traffic received and/or to be transmitted by the network device. In instances that the network device does not transition out of the energy-saving mode, the network device may drop, buffer, or redirect the traffic. In instances that the network device transitions out of the energy-saving mode, the network device may process and/or forward the traffic, and/or convey the traffic up a protocol stack of the network device. The network device may determine whether to transition out of the energy-saving mode based on information stored in a table and/or in register(s) that reside within a PHY and/or within portions of the network device associated with implementing higher OSI layer functions.

### CROSS-REFERENCE TO RELATED APPLICATIONS/INCORPORATION BY REFERENCE

Not Applicable.

### FIELD OF THE INVENTION

Certain embodiments of the invention relate to networking. More specifically, certain embodiments of the invention relate to a method and system for traffic based decisions for energy efficient networking.

### BACKGROUND OF THE INVENTION

The explosion in availability of electronic communication devices, including desktop computers, laptop computers, and various handheld devices such as smart phones and PDA's, and the increased availability of Broadband connectivity including cable, DSL, and next-generation cellular, have led the shift to increased dependence on electronic networks for both business and pleasure. In this regard, electronic networks of all kinds are increasingly being utilized to exchange data that includes voice, web traffic, and/or multimedia. Accordingly, as an increasing number of portable and/or handheld devices become available and more extensively utilized to exchanging increasing amounts of data, battery life is becoming an important consideration in the design of networks and networking devices. Accordingly, ways of reducing power consumption when communicating over electronic networks may be needed.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for traffic based decisions for energy efficient networking, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an exemplary network comprising devices operable to implement energy efficient networking (EEN) protocols, in accordance with an embodiment of the invention.

FIG. 1B is a diagram illustrating configuration and coordination of EEN enabled network devices, in accordance with an embodiment of the invention.

FIG. 2 is a block diagram of an exemplary network device operable to control its mode of operation based on traffic class and/or type, in accordance with an embodiment of the invention.

FIGS. 3A-3B are diagrams that each illustrate an exemplary configuration of a mode of operation of network devices based on a type and/or class of traffic, in accordance with an embodiment of the invention.

FIG. 4 is a flow chart illustrating exemplary steps for controlling a mode of operation of a networking device based on traffic type and/or class, in accordance with an embodiment of the invention.

### DETAILED DESCRIPTION OF THE INVENTION

Certain embodiments of the invention may be found in a method and system for traffic based decisions for energy efficient networking. In various embodiments of the invention, a network device may determine whether to transition out of an energy-saving mode based on a type and/or class of traffic received and/or to be transmitted by the network device. In instances that the network device does not transition out of the energy-saving mode, the network device may drop or buffer the traffic, or may reroute and/or redirect the traffic to an active device. In instances that the network device transitions out of the energy-saving mode, the network device may process the traffic for forwarding to another network device, or for conveyance up a protocol stack of the network device. The network device may determine whether to transition out of the energy-saving mode based on information, which is stored, for example, in a look-up table. Each entry representative of the information stored in the look-up table may comprise one or more types and/or classes of traffic and an indication of whether the types and/or classes of traffic warrant transitioning out of the energy-saving mode. In some embodiments of the invention, the type and/or class of traffic may indicate whether the traffic belongs to a stream. The look-up table may be populated via one or more of reservation stream protocol (RSVP) packets, via one or more simple network management (SNMP) messages, and/or via one or more link layer discovery protocol (LLDP) data units. The network device may determine whether to transition out of the energy-saving mode utilizing information stored in one or more registers within a PHY of the network device. In instances that the network device does determine to transition out of the energy-saving mode, it may generate a wake signal and communicate that wake signal to another network device. The energy-saving mode comprises a low power idle (LPI) mode and/or a subset PHY (also referred to as “subrating”) mode.

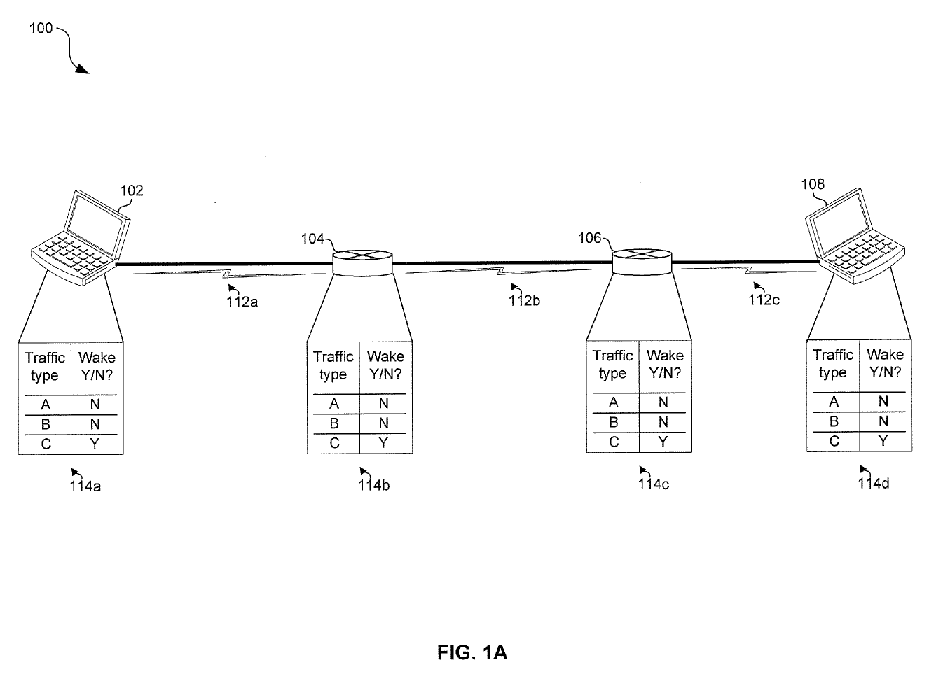

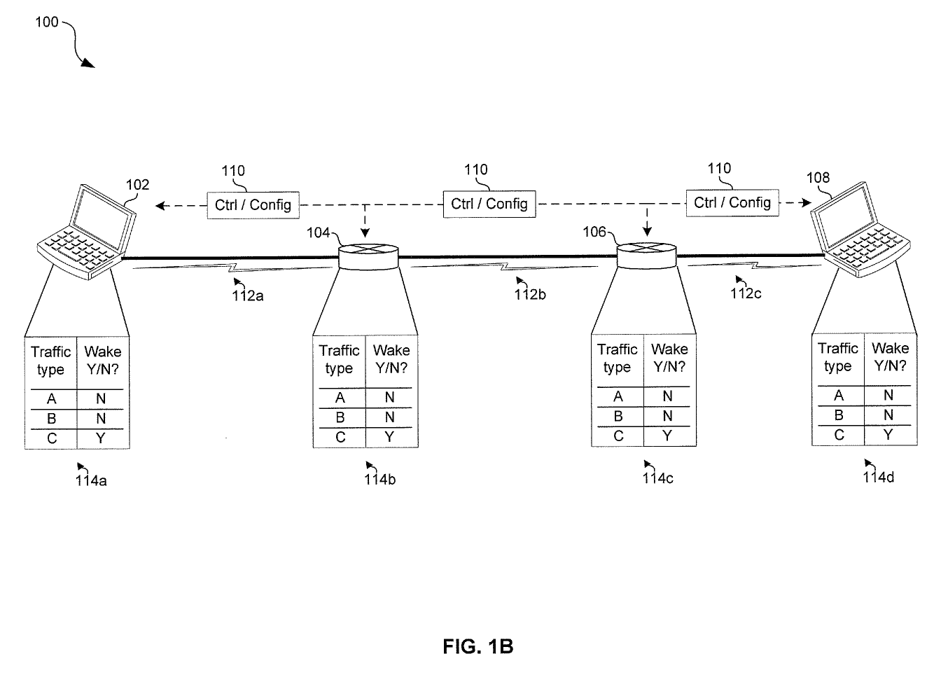

FIG. 1A is a diagram illustrating an exemplary network comprising devices operable to implement energy efficient networking (EEN) protocols, in accordance with an embodiment of the invention. Referring to FIG. 1A there is shown a network 100 comprising network devices 102, 104, 106, and 108 communicatively coupled via network links 112a-112c.

Each of the links 112a-112c may comprise copper, wireless, optical, and/or backplane media. For example, a copper medium such as STP, Cat3, Cat 5, Cat 5e, Cat 6, Cat 7 and/or Cat 7a as well as ISO nomenclature variants may be utilized. Additionally, copper media technologies such as InfiniBand, Ribbon, and backplane may be utilized. With regard to optical media, single mode fiber as well as multi-mode fiber may be utilized. With regard to wireless, the network devices 102, 104, 106, and 108 may support one or more of the 802.11 family of protocols.

The network devices 102, 104, 106, and 108 may each comprise suitable logic, circuitry, interfaces, and/or code that may be operable to communicate over a network. The network devices 102, 104, 106, and 108 may each comprise, for example, a switch, a router, an end-point, a computer system, audio/video (A/V) enabled equipment, or a combination thereof. A/V equipment may, for example, comprise a microphone, an instrument, a sound board, a sound card, a video camera, a media player, a graphics card, or other audio and/or video device. Additionally, the network devices 102 and 104 may be enabled to utilize Audio/Video Bridging and/or Audio/video bridging extensions (collectively referred to herein as audio video bridging or AVB) for the exchange of multimedia content and associated control and/or auxiliary data. Also, the network devices 102, 104, 106, and 108 may be operable to implement security protocols such IPsec and/or MACSec.

Additionally, each of the network devices 102, 104, 106, and 108 may each comprise suitable logic, circuitry, interfaces, and/or code may be operable to implement one or more energy efficient networking (EEN) protocols, which in the case of Ethernet, may be referred to as energy efficient Ethernet (EEE). Exemplary EEN techniques comprise low power idle (LPI) and subset PHY (also referred to as “subrating”). Accordingly, the devices may each operate in various modes, where one or more of the modes may be an energy-saving or “sleep” mode. An energy-saving mode may comprise, for example, a low power idle (LPI) mode and/or a subset PHY mode. LPI may generally refer a family of techniques where, instead of transmitting conventional IDLE symbols during periods of inactivity, network devices may remain silent and/or communicate signals other than conventional IDLE symbols. Sub-rating, or sub-set PHY, may generally refer to a family of techniques where the PHYs, and/or other portions of a network device, are reconfigurable, in real-time or near real-time, to communicate at different data rates. In various embodiments of the invention, an energy-saving mode may be achieved by reconfiguring various portions of a network device. Exemplary reconfigurable portions may comprise a MAC, a PHY, and/or higher layer functions and/or modules such as a CPU, system memory, and/or a data bus such as a PCI bus.

Each of the network devices 102, 104, 106, and 108 may utilize an EEN control policy to implement EEN (or “EEE” for the specific case of Ethernet) techniques. In this regard, the control policy may determine conditions, parameters, events, or other factors that may be utilized in deciding, for example, when to transition into and out-of an energy-saving mode, how to implement an energy-saving mode, and/or which energy-saving mode to utilize. Transitioning into an energy-saving mode to a high(er) energy mode is also referred to herein as “going to sleep.” For example, going to sleep may comprise powering down and/or disabling portions of a PHY such as echo cancellers, crosstalk cancellers, transmitters, and/or receivers; going to sleep may also comprise powering down and/or disabling functions at higher OSI layers such as a MAC and/or a PCI bus. Transitioning out-of an energy-saving mode to a high(er) energy mode is also referred to herein as “waking up.” For example, waking up may comprise powering up and/or enabling portions of a PHY such as echo cancellers, crosstalk cancellers, transmitters, and/or receivers; waking up may also comprise powering up and/or enabling functions at higher OSI layers such as a MAC or PCI bus.

The network devices 102, 104, 106, and 108 may be operable to determine a type and/or class of received and/or to-be-transmitted traffic. Exemplary types and/or classes of traffic may comprise general internet or web traffic, streaming traffic or traffic that belongs to a stream, audio content, video content, and VoIP traffic. In this regard, the types and/or classes of traffic may comprise priority information such as may be utilized as part of the AVB suite of protocols. In various embodiments of the invention, look-up tables 114 may be utilized for determining whether to transition out of an energy-saving mode based on a traffic class and/or type associated with received data and/or data to be transmitted. In this regard, the network devices 102, 104, 106, and 108 may comprise look-up tables 114a, 114b, 114c, and 114d, which are referenced individually or collectively herein as look-up table(s) 114.

In one embodiment of the invention, each entry of a table 114 may comprise a wake_up bit associated with each traffic class and/or type, and assertion of the wake_up bit, i.e. wake=“Yes”, may indicate that the device should wake up when traffic of that type and/or class is received and/or pending transmission by the network device. Conversely, de-assertion of the wake_up bit, i.e. wake=“No”, may indicate that the device should not wake up if traffic of that type and/or class is received and/or pending transmission. In this latter case, traffic may either be buffered and/or dropped until the device is awakened or may be rerouted and/or redirected to a different network device that is active. In this regard, in some embodiments of the invention, some ports of a network device may be active, while others are sleeping. Accordingly, a network device may be operable to forward the traffic via an active port without awakening the sleeping port via which the traffic arrived. In other embodiments of the invention, redirecting the traffic may comprise communicating a signal or reply message to the originating device to indicate that the traffic should be redirected. In this regard, the reply signal and/or message may be simple and/or deterministic such that a device need not wake up to send it.

In various embodiments of the invention, each entry of a table 114 may comprise a field that indicates how long a class and/or type of traffic associated with that table entry may be delayed. In this manner, a table 114 may indicate an amount of time that a network device may sleep based on class and/or type of traffic being communicated to, or waiting to be communicated to, the network device.

In various embodiments of the invention, the each entry of a table 114 may indicate a data rate to which the network device should transition to upon receiving traffic of a particular class and/or type. In this regard, in instances that subrating is utilized, the network device may transition from a first data rate to a second data rate upon receiving data of a particular type and/or class.

In various embodiments of the invention, one or more registers may be utilized instead of or in addition to the tables 114 for determining whether to transition out of an energy-saving mode based on a traffic class and/or type associated with received data and/or to-be-transmitted data. In this regard, the register(s) may be implemented in, for example, a physical layer device (PHY). The register(s) may provide the same or similar indications as the look-up table(s) 114.

For illustration, an exemplary operation is described with regard to traffic originating from the device 102. In this regard, the network device 102 may generate traffic destined for the network device 108 and communicate the traffic onto the link 112a. The traffic may subsequently arrive at the network device 104. In instances that the network device 104 is in an energy-saving or “sleep” mode, the network device 104 may determine whether to transition out of the energy saving mode based on the type and/or class of the traffic. In making this determination, the look-up table 114b may be utilized. In instances that the network device 104 wakes up, or was not in a sleep mode to begin with, the network device 104 may process the traffic and forward it onto the link 112b.

The traffic may subsequently arrive at the network device 106. In instances that the network device 106 is in an energy-saving or “sleep” mode, the network device 106 may determine whether to transition out of the energy-saving mode based on the type and/or class of the traffic. In making this determination, the look-up table 114c may be utilized. In instances that the network device 106 wakes up, or was not in a sleep mode to begin with, the network device 106 may process the traffic and forward it onto the link 112c.

The traffic may subsequently arrive at the network device 108. In instances that the network device 108 is in an energy-saving or “sleep” mode, the network device 108 may determine whether to transition out of the energy-saving mode based on the type and/or class of the traffic. In making this determination, the look-up table 114d may be utilized. In instances that the network device 108 wakes up, or was not in a sleep mode to begin with, the network device 108 may process the traffic and may, for example, pass it up the protocol stack to a process or application.

FIG. 1B is a diagram illustrating configuration and coordination of EEN enabled network devices, in accordance with an embodiment of the invention. Referring to FIG. 1B, there is again shown the network 100.

In operation, the look-up tables 114 may be populated via control messages and/or signals 100 exchanged between the network devices 102, 104, 106, and 108. In one embodiment of the invention, the control messages and/or signals 110 may be messages sent in accordance with protocols such as audio video bridging (AVB) protocols, resource reservation protocol (RSVP), and/or additions and/or enhancements to such protocols. In this regard, the control messages and/or signals 110 may comprise RSVP packets, and a network device may populate its look-up table 114 based on received RSVP packets. For example, RSVP packets may be sent out to reserve resources for traffic of a particular type and the network devices may assert the wake_up bit associated with that traffic type upon receiving the RSVP packets. In another embodiment of the invention, the control messages and/or signals 110 may be sent in accordance with a management protocol such as SNMP. In another embodiment of the invention, the tables 114 may be populated manually by a network administrator. In another embodiment of the invention, values of the tables 114 may be populated by exchanging link layer discover protocol (LLDP) data units. In another embodiment of the invention, values of the tables 114 may be populated by exchanging Ethernet frames comprising a unique and/or distinct Ethertype. In this regard, a network node may inspect a received packet and, upon detecting the distinct Ethertype associated with updating the tables 114, extract information from the packet for updating its table 114. Additionally or alternatively, other OSI layer 2 and/or OSI layer 3 protocols may be utilized for exchanging information to populate the tables 114.

In another embodiment of the invention, one device may operate as a “master” device and may make determinations as to whether other nodes should be awakened for various traffic types and/or classes. Accordingly, the master device may send messages to other devices in the network to populate the information stored in look-up tables and/or registers in the other devices. In this regard, the master may send, for example, LLDP, SNMP, RSVP messages to the other devices to populate the look-up tables and/or registers. In one embodiment of the invention, the master device may be an ingress node to a network and, based upon a type and/or class of traffic arriving at the network, the master device may: send out one or more control signals to wake up the other nodes of the network, drop or buffer the traffic and allow the rest of the network to remain in an energy saving state, or redirect traffic to a network device (or network or sub-network) that is not in an energy-saving mode. Redirecting may comprise sending a notification to a device from which the traffic arrived and/or forwarding the traffic via a port of the network device that is not sleeping.

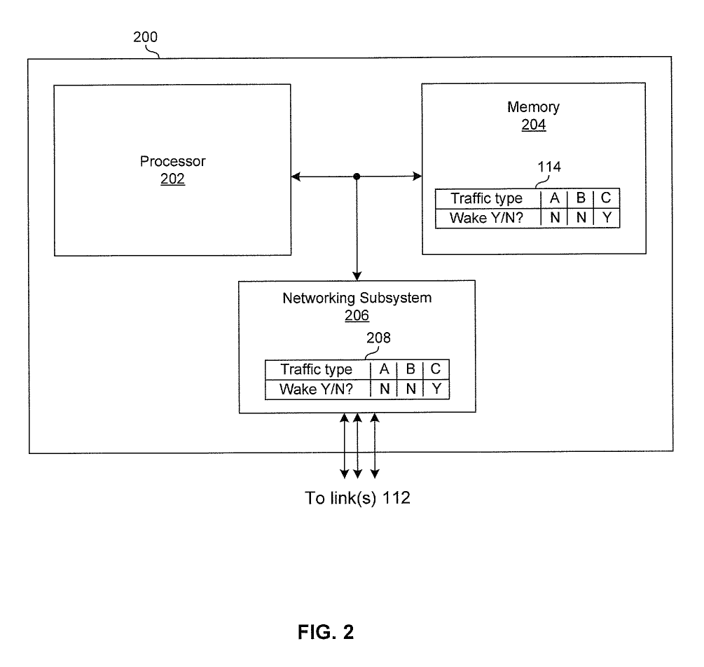

FIG. 2 is a block diagram of an exemplary network device operable to control its mode of operation based on traffic class and/or type, in accordance with an embodiment of the invention. Referring to FIG. 2 there is shown a network device 200 which may be similar to, or the same as, one or more of the devices 102, 104, 106, and 108 described with respect to FIG. 1. The network device 200 may comprise a processor 202, a memory 204, and a networking subsystem 206.

The processor 202 may comprise suitable logic, circuitry, and/or code that may enable processing data and/or controlling operations of the network device 200. With regard to processing data, the processor 202 may enable packetization, de-packetization, transcoding, reformatting, and/or otherwise processing data received from and/or to be transmitted by the networking subsystem 206. With regard to controlling operations of the network device 200, the processor 202 may be enabled to provide control signals to the various other portions of the network device 200. The processor 202 may also control data transfers between various portions of the network device 200. The processor 202 may enable execution of applications programs and/or code. In this regard, the applications, programs, and/or code may enable, for example, parsing, transcoding, or otherwise processing data. Furthermore, the applications, programs, and/or code may enable, for example, configuring or controlling operation of the networking subsystem 206, and/or the memory 204.

The memory 204 may comprise suitable logic, circuitry, and/or code that may enable storage or programming of information that includes parameters and/or code that may effectuate the operation of the network device 200. The parameters may comprise configuration data and the code may comprise operational code such as software and/or firmware, but the information need not be limited in this regard. Additionally, the parameters may include adaptive filter and/or block coefficients. Additionally, the memory 160 may buffer or otherwise store received data and/or data to be transmitted. Additionally, the memory 204 may comprise a look-up table 114. In this regard, the tables 114 may be realized in portions of the network device 200 that are operable to implement higher OSI layer functions. The table 114 may be as described with respect to FIGS. 1A and 1B.

The networking subsystem 206 may comprise suitable logic, circuitry, and/or code that may be operable to transmit and receive data in adherence to one or more networking standards. The networking subsystem 206 may be operable to transmit and/or receive data via, for example, a T1/E1 line, a passive optical network, DSL, a cable television infrastructure, a satellite broadband internet connection, a satellite television infrastructure, a cellular network, Bluetooth, wireless Ethernet, WiMAX, and/or wired Ethernet. The networking subsystem 206 may be operable to implement, switching, routing, and/or network interface card (NIC) functions. In this regard, the networking subsystem 206 may implement physical layer functions, data link layer functions, and may even implement functions associated with OSI layer 3 and higher layers. In this regard, the networking subsystem 206 may comprise, for example, a physical layer device (PHY) and a media access controller (MAC).

Additionally, the networking subsystem 206 may comprise one or more registers and/or memory elements 208 that may indicate whether one or more traffic types and/or classes warrant transitioning out of an energy-saving mode. In this regard, the tables 114 may reside, for example, in a PHY of the networking subsystem, in a MAC of the networking subsystem, in portions of the networking subsystem 206 operable to implement higher OSI layer functions, or the tables 114 may reside in a combination thereof. In some embodiments of the invention, the tables 114 may be implemented in a combination of the registers and/or memory elements 208 and the memory 204.

In various embodiments of the invention, the networking subsystem 206 may comprise one or more ports for communicating via a corresponding one or more network links 112. The one or more ports may be configured independently of one another. Accordingly, the look-up tables 114 and/or registers 208 may comprise per-port information for controlling transitions into and/or out-of energy saving mode of operation on a per-port basis. For example, ports associated with a first VLAN may be configured differently and/or transition based on different conditions and/or events than ports associated with a second VLAN

The network device 200 may operate in different modes during different time periods. One or more of these modes may be an energy-saving mode. The mode in which the network device 200 operates may be controlled based on a type and/or class of traffic received via a link 112. Additionally and/or alternatively, a mode of operation of the network device 200 may be controlled based on a type and/or class of traffic to be transmitted by the network device 200.

In operation, the network device 200 may be operable to detect a type and/or class of traffic received via the link(s) 112, look-up the detected type and/or class in the table 114, and configure or reconfigure itself based on the results of the look-up(s). In instances that a port the network device 200 is operating in an energy-saving mode and the table 114 indicates that the type and/or class of traffic received on that port does not warrant waking up, the received traffic may be dropped or buffered for later transmission or may be redirected to another network device. In instances that a port of the network device 200 is operating in an energy-saving mode, and the table 114 indicates that the type and/or class of traffic received on that port does warrant waking up, the port may be reconfigured and may transition out of the energy-saving mode and process the received data.

The network device 200 may also be operable to detect a type and/or class of traffic to be transmitted by the network device 200, look-up the detected type and/or class in the table 114, and configure or reconfigure itself based on the results of the look-up. For example, the networking subsystem 206 may receive traffic from a higher OSI layer process and/or application and determine whether to reconfigure itself and/or other portions of the network device 200 based on the type and/or class of the traffic. In instances that the networking subsystem 206 is operating in an energy-saving mode and the table 114 indicates that the type and/or class of traffic from the higher OSI layer process and/or application does not warrant waking up, the traffic may be dropped or buffered for later transmission. Additionally, the process and/or application generating the traffic, and/or a user of the process and/or application, may be notified. In one embodiment of the invention, the user may be presented with the option of reconfiguring the table 114 or deferring transmission until the networking subsystem 206 wakes up. In instances that the networking subsystem 206 is operating in an energy-saving mode and the table 114 indicates that the type and/or class of traffic from the higher OSI layer process and/or application does warrant waking up, the networking subsystem 206, the processor 202, and/or the memory 204 may be reconfigured to process and transmit the data. In some embodiments of the invention, only ports of the networking subsystem 206 via which the traffic is to be transmitted may be reconfigured.

In some embodiments of the invention, the network device 200 may maintain a table 114 that indicates when to wake up one or more other network devices. In such instances, when data to be transmitted by the network device 200 warrants waking up one or more of those other network devices, the network device 200 may transmit a wake signal to those other network devices.

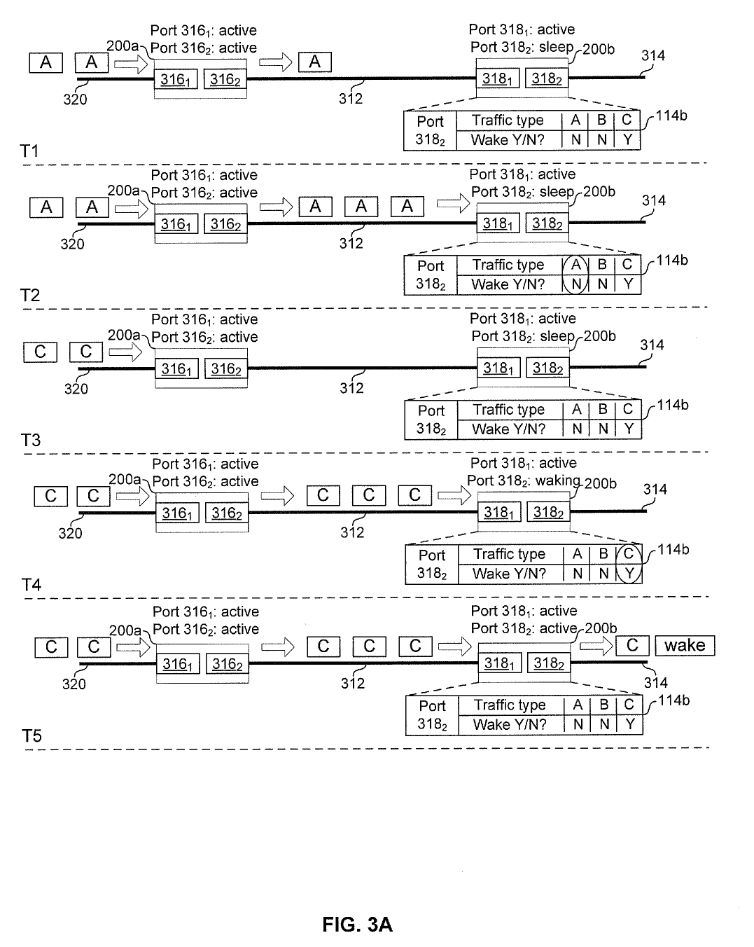

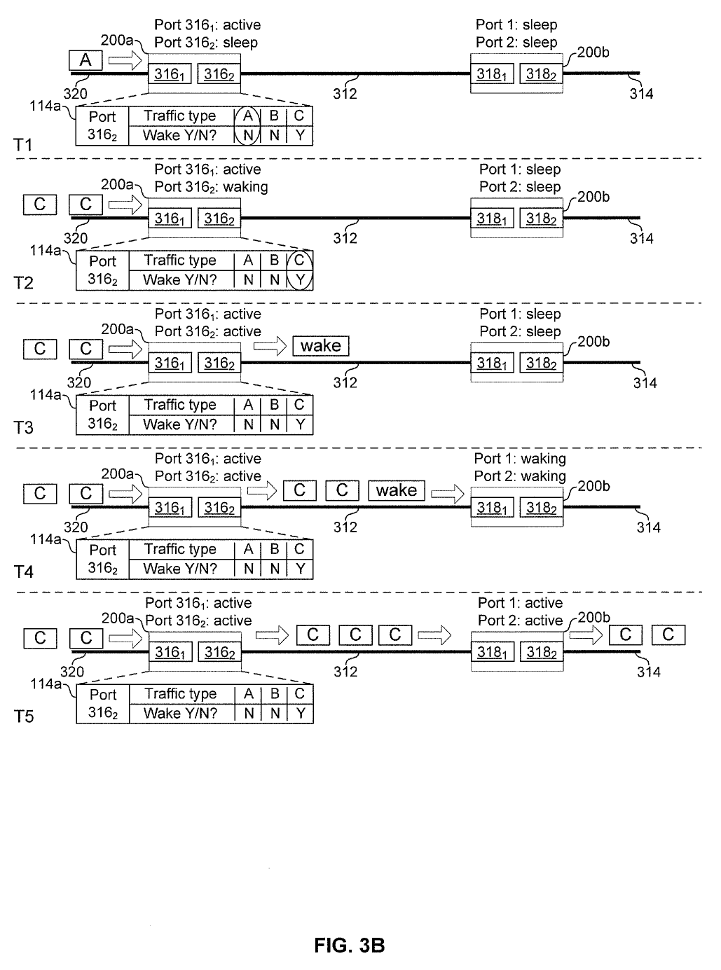

FIGS. 3A-3B are diagrams that each illustrate exemplary configuration of a mode of operation of network devices based on a type and/or class of traffic, in accordance with an embodiment of the invention.

Referring to FIG. 3A, there is shown network devices 200a and 200b which may be the same as the network device 200 described with respect to FIG. 2. The network devices 200a and 200b may be communicatively coupled via a link 312 which may be the same as the links 112 described with respect to FIG. 1. The network device 200a may also be communicatively coupled to additional device(s) via a link 320, which may be the same as the link 112. The network device 200b may also be communicatively coupled to additional device(s) via a link 314, which may be the same as the link 112. Also shown is a portion of a look-up table 114b of the network device 200b. The portion of the table 114a shown in FIG. 3B is associated with port 316₂ of the network device 200a. The portion of the table 114b shown in FIG. 3A is associated with port 318₂ of the network device 200b. The tables 114a and 114b may be the same as the tables 114 described with respect to FIGS. 1A-2.

At time instant T1, the ports 316₁ and 316₂ of the network device 200a and port 318₁ of the network device 200b may be in a mode of operation to process and transmit network traffic, i.e., “active”; the port 318₂ of the network device 200b may be in an energy-saving mode, i.e., “sleeping”. The network device 200a may receive traffic of type A via the port 316₁, process the traffic, and transmit the type A traffic via the port 316₂ onto the link 312.

At time instant T2, the type A traffic may begin arriving at port 318₁ of the network device 200b and the network device 200b may determine an egress port of the traffic to be port 318₂. The network device 200b may detect the traffic as being type A, and look up type A in its table 114b. The table 114b indicates that port 318₂ does not wake up for type A traffic. Accordingly, the type A traffic may be dropped by the network device 200b, may be buffered for forwarding at a later time when the port 318₂ becomes active, or may be redirected to another network device via a different port—either port 316₁ or another active port not shown in FIG. 3A.

At time instant T3, traffic of type C may begin arriving at port 316₁ of the network device 200a. The traffic may be processed and transmitted onto the link 312 via the port 316₂.

At time instant T4, the type C traffic may begin arriving at port 318₁ of the network device 200b and the network device 200b may determine an egress port of the traffic to be port 318₂. The network device 200b may detect the traffic as being type C, and look up type C in its table 114b. The table 114b indicates that port 318₂ should wake up for type C traffic. Accordingly, the network device 200b may begin a transition out of the energy-saving mode. The type C traffic may be buffered while the network device 200b wakes up.

At time instant T5, the port 318₂ may have completed the transition to an active state. Accordingly, the network device 200b may transmit a wake signal on the link 314 and subsequently transmit the type C traffic may be via the port 318₂ onto the link 314.

Referring to FIG. 3B, there is shown the network devices 200a and 200b described with respect to FIG. 3A.

At time instant T1, port 316₁ of the network device 200a may be active and port 316₂ of the network device 200a and ports 318₁ and 318₂ of the network device 200b may each be in an energy-saving mode of operation, i.e., “sleeping.” The network device 200a may detect traffic as being type A, and look up type A traffic in its table 114a. The table 114a comprises information which indicates that the port 316₂ does not wake up for type A traffic. Accordingly, the network device 200a may be operable to drop the type A traffic, buffer the traffic for processing and/or transmission at a later time when the port 316₂ becomes active, or redirect the traffic to another network device.

At time instant T2, traffic of type C may begin arriving at the network device 200a. The network device 200a may detect the traffic as being type C, and look up type C in its table 114a. The table 114a indicates that the port 316₂ of the network device 200b should wake up for type C traffic. Accordingly, the network device 200a may be operable to initiate a transition out of the energy saving mode. The type C traffic may be buffered at least for the period required for the port 316₂ of the network device 200a to wake up.

At time instant T3, the network device 200b may have completed the transition to an active state. The network device 200a may send one or more wake signals onto the link 312 to one or more devices along a network path for which the traffic is destined. In an exemplary embodiment of the invention, the network device 200a may be operable to buffer the traffic until the network device 200b acknowledges the wake signal. In another embodiment of the invention, the network device 200a may be operable to send the traffic shortly after the wake and the network device 200b may buffer the traffic while it wakes up.

At time instant T4, the wake signal may arrive at the network device 200b and the network device 200b may begin to transition out of the energy-saving mode. In some embodiments of the invention, the network device 200b may send an acknowledgment packet of the wake signal and/or may send a signal and/or message to indicate when it is active and ready to receive traffic.

At time instant T5, the type C traffic may be arriving at the network device 200b via the port 318₁. The network device 200b may process the traffic and forward the traffic via the port 318₂.

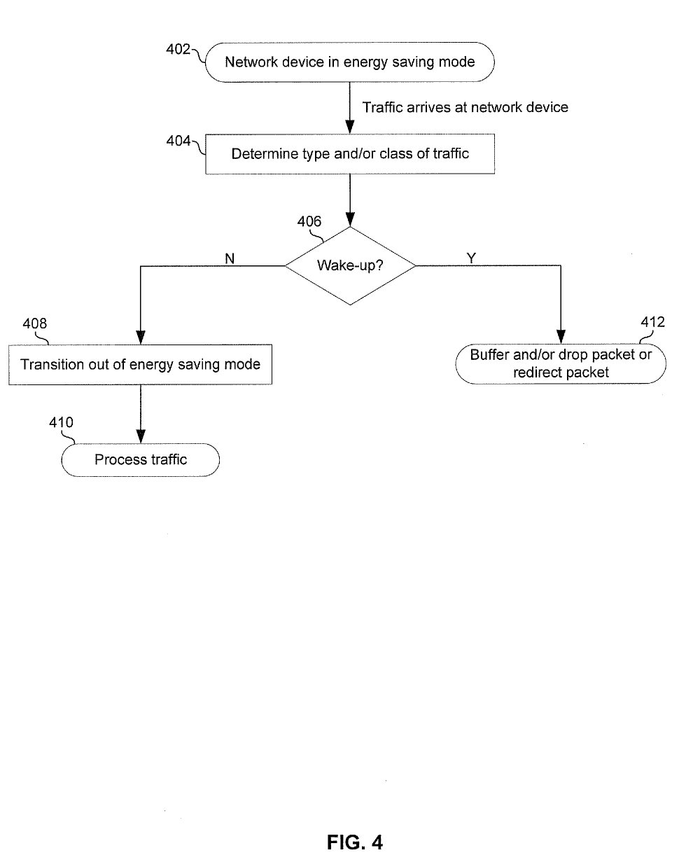

FIG. 4 is a flow chart illustrating exemplary steps for controlling a mode of operation of a networking device based on traffic type and/or class, in accordance with an embodiment of the invention. Referring to FIG. 4, the exemplary steps may begin with step 402 when a network device, such as the network device 200, is operating in an energy-saving mode. When traffic arrives at the network device, the exemplary steps may advance to step 404.

In step 404, the network device 200 may be operable to determine a class and/or type of the received traffic. For example, the network device 200 may compare one or more fields or portions of a received packet to one or more classifiers and/or identifiers. A lookup table or similar data structure may be utilized to determine the type and/or class. Subsequent to step 404, the exemplary steps may advance to step 406.

In step 406, the network device 200 may be operable to determine, based on the type and/or class of the traffic, whether to transition out of the energy-saving mode, i.e., “wake up.” A look-up table, information stored in one or more registers and/or mechanisms, for example, may be utilized to determine whether to wake up. In instances that the network device that does not wake up, the exemplary steps may advance to step 412.

In step 412, the network device 200 may be operable to drop the traffic, buffer the traffic for later processing when the network device becomes active, or redirect the traffic to an active network device. In some embodiments of the invention, the network device may be operable to notify a source of the traffic that the traffic is being dropped, will be processed later, is being and/or has been redirected, or should be directed. In this regard, the indication may, for example, be a physical layer signal that the network device 200 may be operable to generate while in a sleep mode.

Returning to step 406, in instances that the network device 200 does wake up to process the received traffic, the exemplary steps may advance to step 408. In step 408, the network device 200 may transition to an active state. In this regard, one or more portions of the network device 200 may be powered up, reconfigured, and/or trained. The network device 200 may be operable to buffer the traffic during the transition to an active state. Subsequent to step 408, the exemplary steps may advance to step 410.

In step 410, the network device 200 may be operable to process the received traffic. In this regard, the traffic may be processed for forwarding to another network device and/or may be processed for conveyance up a protocol stack for use by a process and/or application, and/or to present information to a user.

In various embodiments of the invention, a network device 200 may determine whether to transition out of an energy-saving mode based on a type and/or class of traffic received and/or to be transmitted by the network device 200. In instances that the network device 200 does not transition out of the energy-saving mode, the network device 200 may drop or buffer the traffic or redirect the traffic. In instances that the network device 200 transitions out of the energy-saving mode, the network device 200 may process the traffic for forwarding to another network device, or for conveyance up a protocol stack of the network device. The network device may determine whether to transition out of the energy-saving mode based on information, which may be stored, for example, in a look-up table 114. Each entry representative of the information stored in the look-up table 114 may comprise one or more types and/or classes of traffic and an indication of whether the types and/or classes of traffic warrant transitioning out of the energy-saving mode. The look-up table 114 may be populated via one or more of reservation stream protocol (RSVP) packets, via one or more simple network management (SNMP) messages, and/or via one or more link layer discovery protocol (LLDP) data units. The network device 200 may determine whether to transition out of the energy-saving mode utilizing information stored in one or more registers 208 within a networking subsystem 206 of the network device. In instances that the network device 200 does determine to transition out of the energy-saving mode, it may generate a wake signal and communicate that wake signal to another network device. The energy-saving mode comprises a low power idle (LPI) mode and/or a subset PHY mode.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for traffic based decisions for energy efficient networking.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments failing within the scope of the appended claims.

What is claimed is:

1. A method for networking, the method comprising:
performing, by one or more circuits and/or processors in network device:
determining whether to transition out of an energy-saving mode based on a type and/or class of traffic received and/or to be transmitted by said network device;
dropping, buffering, or redirecting said traffic in instances that said network device does not transition out of said energy-saving mode; and
processing said traffic for forwarding to another network device, or for conveyance up a protocol stack of said network device, in instances that said network device transitions out of said energy-saving mode.

2. The method according to claim 1, comprising determining whether to transition out of said energy-saving mode based on information stored in a look-up table and/or in one or more registers.

3. The method according to claim 2, wherein said information stored in said look-up table and/or in said one or more registers comprises one or more types and/or classes of traffic and an indication of whether said types and/or classes of traffic warrant transitioning out of said energy-saving mode.

4. The method according to claim 2, wherein said information stored in said look-up table and/or said one or more registers is populated via one or more reservation stream protocol (RSVP) packets.

5. The method according to claim 2, wherein said information stored in said look-up table and/or said one or more registers is populated via one or more simple network management (SNMP) messages.

6. The method according to claim 2, wherein said information stored in said look-up table and/or said one or more registers is populated via one or more link layer discovery protocol (LLDP) data units.

7. The method according to claim 2, wherein said information stored in said look-up table and/or said one or more registers is populated via one or more Ethernet frames comprising a distinct Ethertype that indicates that said one or more Ethernet frames comprise information for populating said look-up table.

8. The method according to claim 2, wherein said information stored in said look-up table and/or said one or more registers indicates an amount of time that said network device may sleep when traffic of a particular type and/or class is pending transmission to and/or from said network device.

9. The method according to claim 1, comprising, in instances that said network device does determine to transition out of said energy-saving mode, generating a wake signal and communicating that wake signal to another network device.

10. The method according to claim 1, wherein said energy-saving mode comprises a subset PHY mode and/or a low power idle (LPI) mode.

11. A system for networking, the system comprising:
one or more circuits for use in a network device, wherein said one or more circuits are operable to:
determine whether to transition out of an energy-saving mode based on a type and/or class of traffic received and/or to be transmitted by said network device;
drop, buffer, or redirect said traffic in instances that said network device does not transition out of said energy-saving mode; and
process said traffic for forwarding to another network device, or for conveyance up a protocol stack of said network device, in instances that said network device transitions out of said energy-saving mode.

12. The system according to claim 11, wherein said one or more circuits are operable to determine whether to transition out of said energy-saving mode based on information stored in a look-up table and/or in one or more registers.

13. The system according to claim 12, wherein said information stored in said look-up table and/or in one or more registers comprises one or more types and/or classes of traffic and an indication of whether said types and/or classes of traffic warrant transitioning out of said energy-saving mode.

14. The system according to claim 12, wherein said information stored in said look-up table and/or in one or more registers is populated via one or more reservation stream protocol (RSVP) packets.

15. The system according to claim 12, wherein said information stored in said look-up table and/or in one or more registers is populated via one or more simple network management (SNMP) messages.

16. The system according to claim 12, wherein said information stored in said look-up table and/or in one or more registers is populated via one or more link layer discovery protocol (LLDP) data units.

17. The system according to claim 12, wherein said look-up table is populated via one or more Ethernet frames comprising a distinct Ethertype that indicates that said one or more Ethernet frames comprise information for populating said look-up table.

18. The system according to claim 12, wherein said information stored in said look-up table and/or said one or more registers indicates an amount of time that said network device may sleep when traffic of a particular type and/or class is pending transmission to and/or from said network device.

19. The system according to claim 11, wherein said one or more circuits are operable to generate a wake signal and communicating that wake signal to another network device in instances that said network device does determine to transition out of said energy-saving mode.

20. The system according to claim 11, wherein said energy-saving mode comprises a low power idle (LPI) and/or a subset PHY mode.
